(19) United States
(12) Patent Application Publication
(10) Pub. No.: US 2006/0290082 A1
(43) Pub. Date: Dec. 28, 2006

(54) Shopping cart having improved chassis, handle, and basket construction

(75) Inventor: Val-Jean Duchene, Wagoner, OK (US)

Correspondence Address: WOOD, PHILLIPS, KATZ, CLARK & MORTIMER, 500 W. MADISON STREET, SUITE 3800, CHICAGO, IL, 60661, US

(73) Assignee: Unarco Industries, Inc..

(21) Appl. No.: 11/166,640

(22) Filed: Jun. 24, 2005

(51) Int. Cl. B62B 3/00

(52) U.S. Cl. 280/33.991

(57) ABSTRACT

In shopping cart comprising a chassis, a handle, and a basket, the chassis comprises a frame defining two shoulders. The handle comprises an upper portion extending generally horizontally, two lateral portions extending downwardly and frontwardly from the upper portion, and two lower portions extending rearwardly from the lateral portions, along the shoulders, to which the lower portions are welded. The basket comprises two lateral walls, each welded to one of the lateral portions of the handle, near its upper portion, and a lower member extending across the shopping cart, at a lower, rear edge of the basket, and welded to the lower portions of the handle. A brace extending between the shoulders of the frame, beneath the basket, supports the basket. Preferably, the basket is welded to the handle before the handle, to which the basket is welded, is welded to the chassis. Thereupon, the shopping cart may be powder-coated.

### TECHNICAL FIELD OF THE INVENTION

This invention pertains to a shopping cart of a type comprising a chassis, a handle, and a basket, wherein the chassis and the handle comprise members made from tubular steel.

### BACKGROUND OF THE INVENTION

Shopping carts of the type noted above are exemplified in U.S. Pat. No. 5,401,042 and in U.S. Pat. No. 5,470,087. Commonly, as exemplified therein, the chassis has a tubular, steel frame defining an elevated platform and the handle is a tubular steel handle, which has an upper portion extending generally horizontally and which has two lateral portions extending generally downwardly from the upper portion to the elevated platform and being welded to the elevated platform. Commonly, moreover, the basket is welded or is mounted otherwise to the lateral portions of the handle and is supported by the elevated platform so as to project frontwardly, but not rearwardly, from the lateral portions of the handle.

### SUMMARY OF THE INVENTION

According to a first aspect of this invention, this invention provides a shopping cart comprising a chassis, a handle, and a basket, which are welded to one another. The chassis comprises a frame, which defines two shoulders extending generally horizontally from a rear portion of the chassis toward a front portion of the chassis, spaced laterally from each other, and elevated above other portions of the frame.

The handle comprises an upper portion extending generally horizontally across the shopping cart and spaced upwardly from the shoulders of the frame, two lateral portions, each of which extends downwardly and frontwardly from the upper portion toward the lower frame. The handle comprises two lower portions, each of which extends rearwardly from one of the lateral portions, along one of the shoulders of the frame, each of which is welded to one of the shoulders of the frame, and each of which comprises a distal end. The basket is welded to the handle.

Preferably, the basket comprises two lateral walls, each of which is welded to one of the lateral portions of the handle, near the upper portion of the handle.

Furthermore, the basket comprises a lower, rear member, which extends generally horizontally across the shopping cart, at a lower, rear edge of the basket, and which is welded to the lower portions of the handle, near the distal ends of the lower portions of the handle.

According to a second aspect of this invention, this invention provides a method of assembling a shopping cart comprising a chassis, a handle, and a basket, wherein the chassis comprises a frame, which defines two shoulders extending generally horizontally from a rear portion of the chassis toward a front portion of the chassis, spaced laterally from each other, and elevated above other portions of the frame, wherein the handle comprises an upper portion extending generally horizontally across the shopping cart and spaced upwardly from the shoulders of the frame, two lateral portions, each of which extends downwardly and frontwardly from the upper portion toward the frame of the chassis, and wherein the handle comprises two lower portions, each of which extends rearwardly from one of the lateral portions, along one of the shoulders of the frame. Broadly, the method provided by this invention comprises welding the basket to the handle and welding each of the lower portions of the handle to one of the shoulders of the frame of the chassis.

In one contemplated mode for carrying out the method, wherein each of the lower portions of the handle has a distal end, wherein the basket comprises two lateral walls, each of which has an upper, lateral member, wherein the basket comprises a lower, rear member, which extends generally horizontally across the shopping cart, at a lower, rear edge of the basket, and wherein, when the basket is welded to the handle, the upper, lateral member of each of the lateral walls of the basket is welded to one of the lateral portions of the handle, near the upper portion of the handle, and the lower, rear member of the basket is welded to the lower portions of the handle, near the distal ends of the lower portions of the handle. In a preferred mode for carrying out the method provided by this invention, the basket is welded to the handle before the lower portions of the handle are welded to the shoulders of the frame of the chassis.

### BRIEF DESCRIPTION OF THE DRAWINGS

FIG. 1 is a perspective view of a shopping cart embodying this invention and comprising a chassis, a handle, and a basket. FIG. 2 is an enlarged detail illustrating where one of two lower portions of the handle is welded to one of two shoulders defined by a frame of the chassis. FIG. 3 is an enlarged detail illustrating where one of two lateral walls of the basket is welded to one of two lateral portions of the handle. In FIGS. 1, 2, and 3, certain elements are illustrated schematically or in broken lines, so as to simplify the drawings.

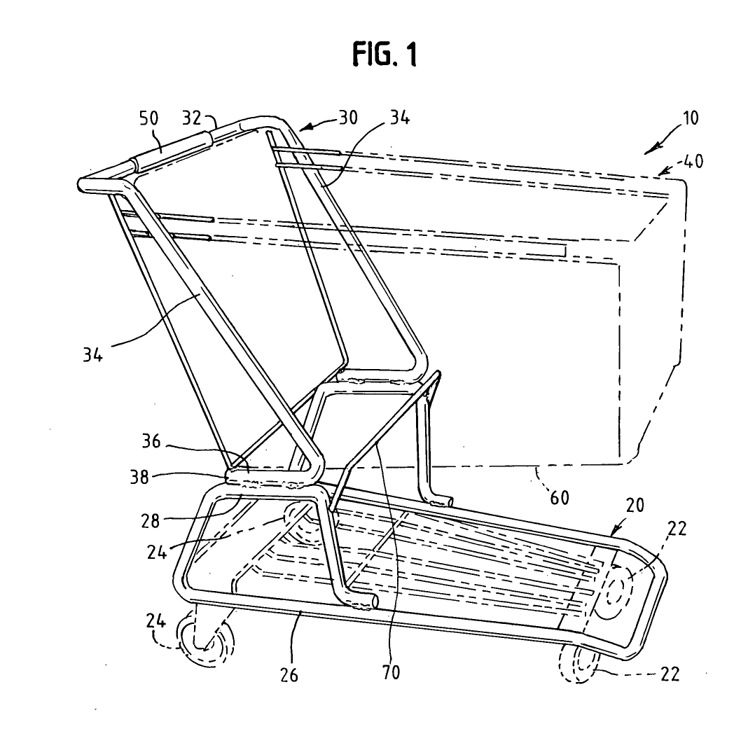

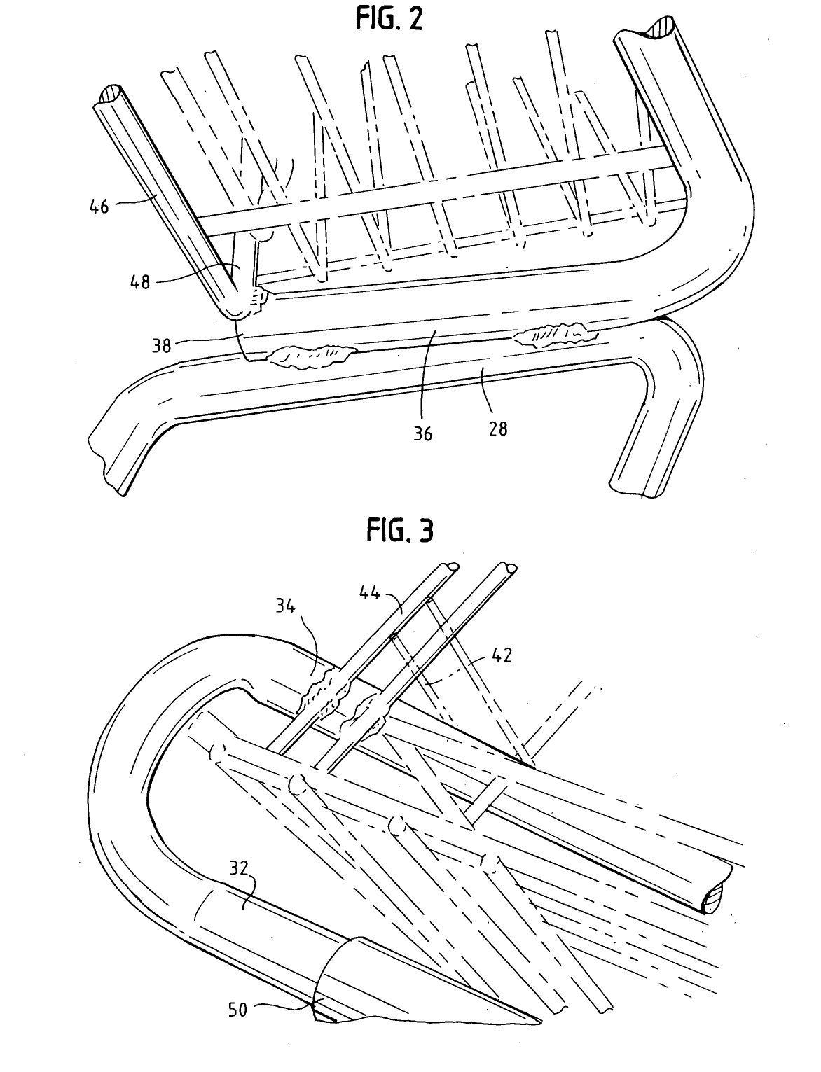

### DETAILED DESCRIPTION OF THE ILLUSTRATED EMBODIMENT

As illustrated, a shopping cart 10 embodying this invention comprises a chassis 20, a handle 30, and a basket 40, in an improved construction, which is described below.

The chassis 20, which mounts conventional front casters 22 and conventional rear casters 24, comprises a one-piece, tubular, steel frame 26, which defines two shoulders 28 extending generally horizontally from a rear portion of the chassis 20 toward a front portion of the chassis 20. The shoulders 28, which are spaced laterally from each other, are elevated above other portions of the frame 26.

In other respects, the chassis 20 may conform to the chassis of shopping carts of the type noted above, as known heretofore. Advantageously, the chassis 20 may conform to the chassis illustrated and described in U.S. patent application Ser. No. 10/937,024, which is entitled “SHOPPING CART CHASSIS”, which was filed on Sep. 9, 2004, and the disclosure of which is incorporated herein by reference.

The handle 30, which is a one-piece, tubular, steel handle of oval cross-section, comprises an upper portion 32 extending generally horizontally across the shopping cart 10 and spaced upwardly from the shoulders 28 of the frame 26. A polymeric grip 50 is applied, conventionally, so as to cover much of the upper portion 32. Moreover, the handle 30 comprises two lateral portions 34, each of which extends downwardly and frontwardly from the upper portion 32 toward the frame 26 of the chassis 20. Furthermore, the handle 30 comprises two lower portions 36, each of which extends rearwardly from one of the lateral portions 34, along one of the shoulders 28 of the frame 26 of the chassis 20. Each of the lower portions 36 is welded to one of the shoulders 28 of the frame 26 of the chassis 20. Each of the lower portions 36 has a distal end 38.

The basket 40, which is made from welded steel wires, comprises two lateral walls 42, each of which is made from welded steel wires including an upper, lateral member (wire) 44 welded to one of the lateral portions 34 of the handle 30, near the upper portion 32 of the handle 34. The basket 40 comprises a rear, wire frame 46 comprising a lower, rear member (wire) 48, which extends generally horizontally across the shopping cart 10, at a lower, rear edge of the basket 40, and which is welded to the lower portions 36 of the handle 30, near the distal ends 38 of the lower portions 36 of the handle 30.

The basket 40 has an underside 60, which is made from welded steel wires. The chassis 20 comprises a brace 70, which extends generally horizontally across the shopping cart 10, between the shoulders 28 of the frame 26 of the chassis 20, beneath the underside 60 of the basket 40.

Rather than the basket 40 made from welded steel wires, a polymeric basket can be alternatively used, so long as the polymeric basket is provided on each side with such an upper, lateral member, which can be similarly welded, and so long as the polymeric basket is provided with such a lower, rear member, which can be similarly welded.

Accordingly, a minor portion of the basket 40 projects rearwardly from the lateral portions 34 of the handle 30, while a major portion of the basket 40 projects frontwardly from the lateral portions 34 of the handle 30 and is supported by the brace 70. Advantageously, therefore, the lateral portions 34 of the handle 30 strengthen the basket 40.

In a preferred mode for assembling the shopping cart 10, the basket 40 is welded to the handle 30, as illustrated and described, before the handle 30, to which the basket 40 is welded, is welded to the chassis 20, as illustrated and described. Thereupon, the shopping cart 10 may be powder-coated, as illustrated.

1. A shopping cart comprising a chassis, a handle, and a basket, wherein the chassis comprises a frame, which defines two shoulders extending generally horizontally from a rear portion of the chassis toward a front portion of the chassis, spaced laterally from each other, and elevated above other portions of the frame, wherein the handle comprises an upper portion extending generally horizontally across the shopping cart and spaced upwardly from the shoulders of the frame, two lateral portions, each of which extends downwardly and frontwardly from the upper portion toward the frame of the chassis, and wherein the handle comprises two lower portions, each of which extends rearwardly from one of the lateral portions, along one of the shoulders of the frame, and each of which is welded to one of the shoulders of the frame of the chassis, and wherein the basket is welded to the handle.

2. The shopping cart of claim 1, wherein each of the lower portions of the handle has a distal end and wherein the basket comprises two lateral walls, each of which has an upper, lateral member welded to one of the lateral portions of the handle, near the upper portion of the handle, and wherein the basket comprises a lower, rear member, which extends generally horizontally across the shopping cart, at a lower, rear edge of the basket, and which is welded to the lower portions of the handle, near the distal ends of the lower portions of the handle.

3. The shopping cart of claim 1, wherein the basket has an underside and wherein the chassis comprises a brace, which extends generally horizontally across the shopping cart, between the shoulders of the frame, beneath the underside of the basket.

4. The shopping cart of claim 2, wherein the basket comprises an underside and wherein the chassis comprises a brace, which extends generally horizontally across the shopping cart, between the shoulders of the frame, beneath the underside of the basket.

5. The shopping cart of claim 1, wherein a minor portion of the basket projects rearwardly from the lateral portions of the handle, while a major portion of the basket projects frontwardly from the lateral portions of the handle.

6. The shopping cart of claim 2, wherein a minor portion of the basket projects rearwardly from the lateral portions of the handle, while a major portion of the basket projects frontwardly from the lateral portions of the handle.

7. The shopping cart of claim 3, wherein a minor portion of the basket projects rearwardly from the lateral portions of the handle, while a major portion of the basket projects frontwardly from the lateral portions of the handle.

8. The shopping cart of claim 4, wherein a minor portion of the basket projects rearwardly from the lateral portions of the handle, while a major portion of the basket projects frontwardly from the lateral portions of the handle.

9. The shopping cart of any preceding claim, wherein the frame of the chassis is a one-piece, tubular frame and wherein the handle is a one-piece, tubular handle.

10. A method of assembling a shopping cart comprising a chassis, a handle, and a basket, wherein the chassis comprises a frame, which defines two shoulders extending generally horizontally from a rear portion of the chassis toward a front portion of the chassis, spaced laterally from each other, and elevated above other portions of the frame, wherein the handle comprises an upper portion extending generally horizontally across the shopping cart and spaced upwardly from the shoulders of the frame, two lateral portions, each of which extends downwardly and frontwardly from the upper portion toward the frame of the chassis, and wherein the handle comprises two lower portions, each of which extends rearwardly from one of the lateral portions, along one of the shoulders of the frame, and wherein the method comprises welding the basket to the handle and welding each of the lower portions of the handle to one of the shoulders of the frame of the chassis.

11. The method of claim 10, wherein each of the lower portions of the handle has a distal end, wherein the basket comprises two lateral walls, each of which has an upper, lateral member, wherein the basket comprises a lower, rear member, which extends generally horizontally across the shopping cart, at a lower, rear edge of the basket, and wherein, when the basket is welded to the handle, the upper, lateral member of each of the lateral walls of the basket is welded to one of the lateral portions of the handle, near the upper portion of the handle, and the lower, rear member of the basket is welded to the lower portions of the handle, near the distal ends of the lower portions of the handle.

12. The method of claim 10, wherein the basket is welded to the handle before the lower portions of the handle are welded to the shoulders of the frame of the chassis.

13. The method of claim 11, wherein the basket is welded to the handle before the lower portions of the handle are welded to the shoulders of the frame of the chassis.
